(19) United States
(12) Patent Application Publication
(10) Pub. No.: US 2021/0115893 A1
(43) Pub. Date: Apr. 22, 2021

(54) CONNECTION BETWEEN LONGITUDINAL SEGMENTS OF A ROTOR BLADE OF THE ROTOR OF A WIND POWER PLANT

(71) Applicant: VENSYS Energy AG, Neunkirchen (DE)

(72) Inventor: Jürgen RINCK, Ommersheim (DE)

(21) Appl. No.: 17/074,076

(22) Filed: Oct. 19, 2020

(30) Foreign Application Priority Data
Oct. 18, 2019 (DE) 102019128240.3
Oct. 22, 2019 (DE) 102019128487.2

(51) Int. Cl. F03D 1/06

(52) U.S. Cl. CPC F03D 1/0675; F05B 2280/6003; F05B 2260/30; F05B 2240/21

(57) ABSTRACT

A connection between portions of a rotor blade of the rotor of a wind power plant, the rotor blade being divided transversely with respect to the longitudinal axis thereof, wherein the rotor blade has a hollow wing profile having a wall shell on the negative-pressure side and a wall shell on the positive-pressure side, as well as a spar which in the cavity between the wall shells runs in the blade longitudinal direction and which is connected to the wall shells by way of stringer parts of the spar that face the wall shells. The stringer parts of the spar of the rotor blade portions in a connection region are enlarged while forming mutually opposite abutment faces. Recesses for receiving connection elements that project from the opposite abutment face open in at least one of the abutment faces and the connection elements are anchored in a materially integral manner in the receptacle recesses.

### CROSS-REFERENCE TO RELATED APPLICATIONS

The present application claims priority of DE 10 2019 128 240.3, filed Oct. 18, 2019, and DE 10 2019 128 487.2, filed Oct. 22, 2019, the priority of these applications is hereby claimed and this application is incorporated herein by reference.

### BACKGROUND OF THE INVENTION

The invention relates to a connection between portions of a blade of the rotor of a wind power plant, said blade being divided transversely with respect to the longitudinal axis thereof, wherein the rotor blade has a hollow wing profile having a wall shell on the negative-pressure side and a wall shell on the positive-pressure side, as well as a spar which in the cavity between the wall shells runs in the blade longitudinal direction and which is connected to the wall shells by way of stringer parts of the spar that face the wall shells.

As rotor blade length increases, advantages in terms of transportation and production are derived by transversely dividing said rotor blades. Rotor blades which are composed of rotor blade portions are known, for example, from EP 1 761 702 B1, U.S. Pat. No. 9,506,452 B2, EP 2 740 583 B1 and EP 2 264 310 B1.

### SUMMARY OF THE INVENTION

A new connection between portions of a rotor blade of the type mentioned at the outset is achieved by the present invention, said connection being characterized in that the stringer parts of the spars of the rotor blade portions in a connection region are enlarged while forming mutually opposite abutment faces, in that recesses for receiving connection elements that project from the opposite abutment face open in at least one of the abutment faces and in that the connection elements are anchored in a materially integral manner in the receptacle recesses.

While the wall shells largely contain filler material without any supporting function, the spar is primarily relevant for the strength of the rotor blade. According to the invention, the stringer parts of said spar that are enlarged in the connection region are incorporated in the connection in such a manner that said stringer parts serve as supports for a multiplicity of connection elements by way of which abutting ends of the rotor blade portions are held together. The rotor blade according to the invention is thus capable of bearing tensile and shear loads in the same way as a continuous rotor blade.

In one embodiment of the invention, the connection elements are integrally connected to the stringer part that forms the other abutment face. Alternatively, the connection elements are separate parts which extend into receptacle recesses which are mutually aligned in pairs and open in both abutment faces.

The connection elements in the latter embodiment are expediently configured as pin-connection elements having a preferably circular cross section, said pin-connection elements being able to engage in bores that have a corresponding cross section and form the receptacle recesses.

Connection elements that are integrally connected to one of the stringer parts expediently have a flat cross section and engage in receptacle recesses that are configured as narrow pockets.

The connection elements that are integrally connected to one of the stringer parts can be formed by laminated tiers, for example, which protrude from the stringer part connected thereto.

In one further embodiment the connection elements, in addition to the materially integral anchoring, can be additionally anchored in a form-fitting manner in the receptacle recesses, wherein the receptacle recesses are undercut and the connection element can be deformed in order to be introduced into the receptacle recess, for example.

In one further embodiment of the invention at least one of the enlarged stringer parts is formed by a prefabricated component which is completely adhesively bonded to the remaining spar.

The thickness of the wall shells in the region of the connection to the stringer part is expediently reduced such that the stringer part, in terms of the thickness of said wall shells, in this region in portions conjointly assumes the function of the wall shell. In the extreme case, the thickness of the wall shell in this region can be close to zero.

The above-mentioned bores in the enlarged stringer parts proximal to the wall shell are in each case expediently disposed in a line which runs so as to be parallel to the cross-sectional contour of the respective wall shell.

The stringer parts that form support faces for the wall shells can be enlarged in terms of width and/or thickness, wherein the bores are disposed not only in one row which is parallel to the respective wall shell external contour, but in a plurality of such rows, for example.

In one embodiment the stringer parts of the spar are enlarged by way of a laminated construction which is bonded to an endpiece of the remaining stringer part, preferably an endpiece which is tapered by hafting. The laminated construction that forms the enlargement in this instance is hafted in the reverse manner.

In the case of hafting that is once again reversed, the thickness of an end region of the enlargement can slightly decrease toward the abutment face.

The spar expediently has a double-T profile or/and a box profile. The stringer parts in this instance are formed by the T-legs of the double-T profile or by mutually opposite legs of the box profile.

The stringer parts which are enlarged and parallel to the wall shells in the connection region can be supported by in relation to the remaining spar connection parts which absorb additional shear forces.

The mutually opposite abutment faces can bear on one another and be optionally adhesively bonded to one another while sealing the rotor blade interior. However, a minor spacing is preferably formed between the abutment faces such that the enlarged stringer parts and in particular the end sides of the wall shells cannot act on one another at the connection point. The gap at the connection point can be closed by a thin cover which wraps around the rotor blade.

In one further embodiment of the invention the pin-connection element has a thickening, wherein the abutment faces which are mutually opposite in the connection region are in particular disposed in the region of this thickening. The thickening ensures an increased tensile and shear strength at a lower mass of the pin-connection elements.

The thickening of the pin-connection elements is in each case preferably shaped so as to be conical while avoiding stepped shoulders at the ends.

The thickening can be formed by at least one sleeve which is placed onto a pin main body and is in particular fastened by adhesive bonding. The pin main body and the sleeve material are available as finished products. The complexity for the production of such pin-connection elements is correspondingly minor.

In a further embodiment, ducts for injecting an adhesive compound which open in each case toward the internal or external side of the blade as well as such ducts for checking the filling level of a gap between the pin-connection element and the bore wall open out into the blind bores. The check ducts are preferably grooves which are incorporated in the abutment faces.

Alternatively, quantities of adhesive that are sufficient for the adhesive bonding can be filled in a metered manner into the receptacle recesses which open into the abutment faces.

Spacers for centering the pin element within the bore can project radially from the pin-connection element.

The connection elements and the receptacle recesses within a connection can differ in terms of shape, dimensions and material.

The connection element, the reinforcement stringer including the enlargements or/and the wall shells are preferably composed of fiber-composite material. The enlarged stringer parts and optionally the wall shells are particularly in each case a fiber-composite structure.

The rotor blade portions preferably relate to a portion that comprises the free end of the rotor blade and to a portion that comprises the blade root of the rotor blade. However, at least one of the above-described portions could also be connected to a further rotor blade portion at both ends.

In one further embodiment the rotor blade portions at the connection end can have in each case one cover which protects the interior of the rotor blade portion.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows in fragments a rotor blade from rotor blade portions which are connected according to the invention,

FIG. 2 shows a connection end of a rotor blade portion shown in FIG. 1 in a plan view,

FIG. 3 shows a cross section according to the section plane I-I of the rotor blade of FIG. 1,

FIG. 4 shows a detail of an exemplary embodiment of a connection according to the invention by way of a pin-connection element,

FIG. 5 shows a pin-connection element used in the connection of FIG. 4,

FIGS. 6 and 7 show details of a further exemplary embodiment of a connection according to the invention,

FIGS. 8 and 9 show an exemplary embodiment of a stringer part of a rotor blade portion in various views, said stringer part being enlarged according to the invention, and

FIGS. 10 to 12 show further exemplary embodiments of connections according to the invention.

### DETAILED DESCRIPTION OF THE INVENTION

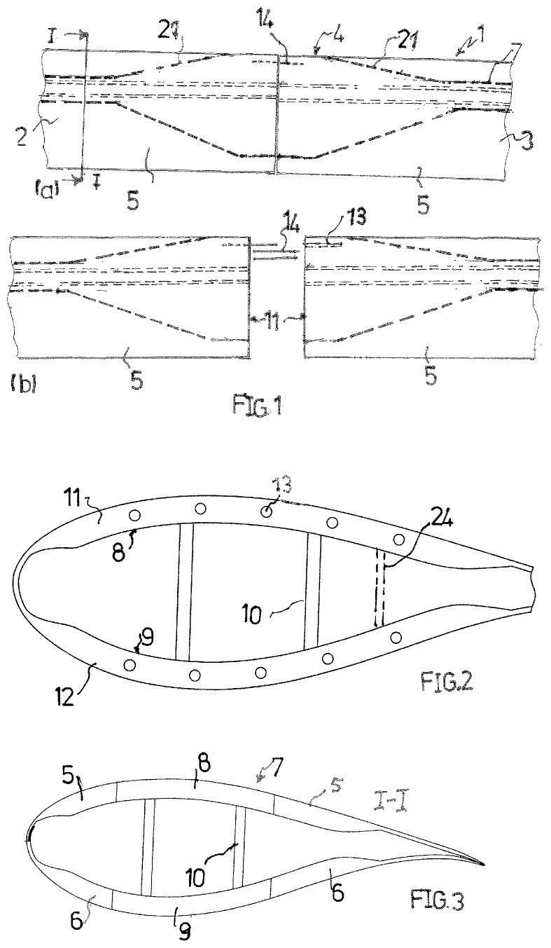

A rotor blade 1, shown in fragments in FIG. 1, of the rotor of a wind power plant which is otherwise not illustrated is transversely divided and in the example has two rotor blade portions 2 and 3, one of the latter comprising the blade root and the other comprising the free blade end (the blade root and the blade end not being visible). A connection region between the rotor blade portions 2, 3 is formed at 4.

The rotor blade portions 2, 3 have a hollow wing profile which in the cross section is shown in FIG. 3 and has a wall shell 5 on the negative-pressure side and a wall shell 6 on the positive-pressure side. FIG. 1 shows the respective negative-pressure sides in a plan view.

A spar 7 which transverses the cavity of the wing profile and runs in the blade longitudinal direction extends between the wall shells 5, 6. The spar 7, shown in the cross section in FIG. 3, has a double-T profile having stringer parts 8, 9 which are parallel to the wall shells 5, 6. The stringer parts 8, 9 engage in each case in recesses in the wall shells 5, 6 and across their entire faces are adhesively bonded to the wall shells 5, 6. The vertical legs of the double-T profile in this example form two webs 10.

The stringer parts 8, 9 in the connection region 4 are enlarged toward the connection end of the rotor blade portions 2, 3 and optionally thickened in portions. At the respective connection end the enlarged stringer parts 8, 9 which are connected to the wall shells 5, 6 form in each case one abutment face 11 or 12, respectively.

Bores 13 which are disposed so as to correspond to a line that runs along the contour of the wall shells 5, 6 open in the abutment faces 11, 12 of the rotor blade portions 2, 3 that are mirror-inverted so as to be mutually opposite in the connection, as can be seen in FIG. 2. The respective bores 13 of the rotor blade portion 2 at the connection point between the rotor blade portions 2, 3 are aligned so as to be axially opposite the corresponding bores 13 of the rotor blade portion 3.

One pin-connector element 14 engages in each case in the mutually aligned bores 13, in the example shown in each case by approximately half the length of said pin-connector element 14. The pin-connector elements 14 are fixed in a materially integral manner in the bores 13.

In addition to the webs 10 of the spar 7 that continue into the connection region 4 in a preferably rectilinear manner, and deviating from FIG. 2, additional connections that absorb shear forces could be established between the enlarged stringer parts 8, 9, as is indicated by dashed lines 24 in FIG. 2.

In the example described, the pin-connection elements 14 as well as all parts shown of the rotor blade portions 2, 3 are preferably composed of fiber-composite material, including carbon-fiber-composite material, wherein the spar 7 including the enlargements is in particular configured as a fiber-composite structure.

The pin-connection elements 14 schematically illustrated in FIG. 1 can have a thickening according to FIG. 4 and FIG. 5. The thickening 15 which in the example is disposed in the longitudinal center of the pin-connection element 14 in the example is disposed so as to be symmetrical in relation to the abutment joint between the rotor blade portions 2, 3 that are connected to one another. According to FIG. 4, the pin-connection element 14 in the bores 13 that are mirror-inverted so as to be mutually opposite is fixed by way of a cured adhesive layer 16. An adhesive layer 17 in the example is furthermore formed between the abutment faces 11, 12 in which the bores 13 that are mirror-inverted so as to be mutually opposite open for receiving the pin-connection elements 14.

The thickening 15 of the pin-connection element 14 shown in FIG. 4 in the example is formed by a sleeve 19 which is push-fitted onto a pin main body 18 and fixed by adhesive bonding. The sleeve 19 at the ends thereof has in each case one conical taper 20. The cross-sectional face of the pin-connection element 14 is circular throughout.

The bore 13 which is enlarged according to the thickening 15 with the aid of a correspondingly shaped boring tool can advantageously be produced in a single operating step.

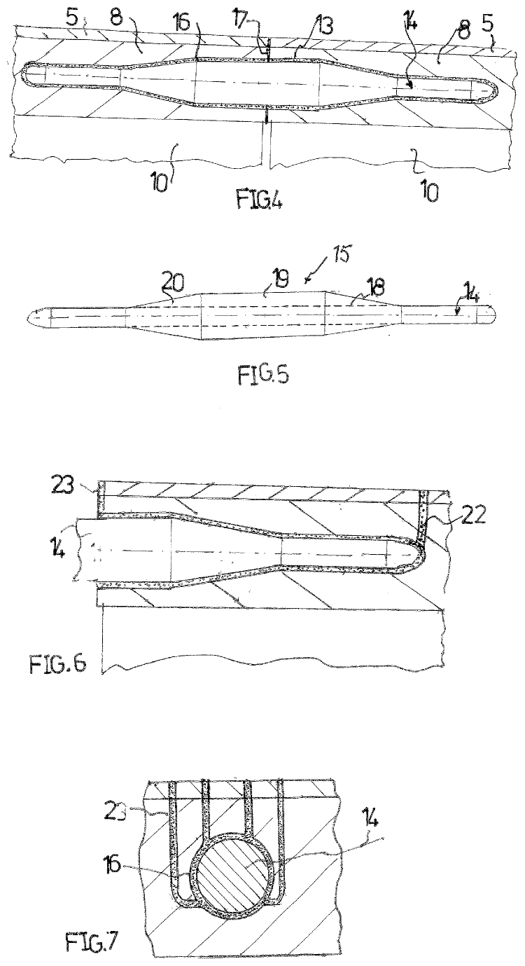

According to FIG. 6, a duct 22 through which adhesive compound is able to be injected into a gap between the pin-connection element 14 and the wall of the bore 13 and which leads to the external side of the rotor blade portion 2, 3 can open out into the bore 13 that receives the pin-connection element 14. The duct 22 expediently opens out at the closed end of the bore 13. At least one check duct which leads to the external side of the rotor blade portion 2 or 3, respectively, can open out into the bore 13 at the open end. A groove 23 which is incorporated in the abutment face 11 or 12, respectively, is expediently formed as the check duct. It is understood that the duct 22, or the groove 23, can also open toward the internal side of the rotor blade.

According to FIG. 7, four such grooves 23 can open out into the bore 13 at locations which are distributed across the circumference of the bore 13, for example. Adhesive compound 16 which from the groove ducts 23 leaks to the outside indicates that the adhesive gap between the pin-connection element 14 and the bore wall is completely filled with adhesive.

Spacers which project radially from an annular support and which center the pin-connection element 14 within the bore 13 and ensure a sufficient gap thickness for receiving adhesive all around can be attached to the pin-connection element 14, for example.

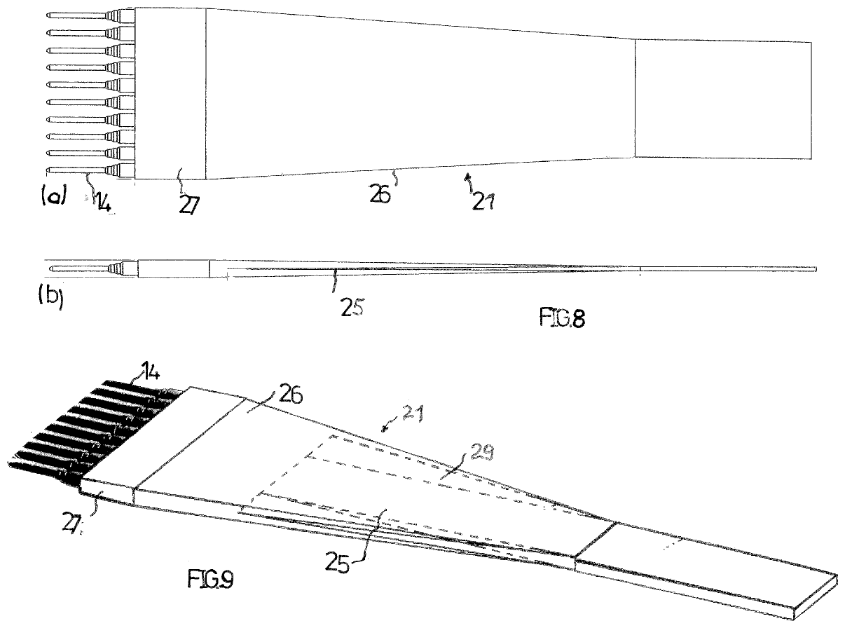

FIGS. 8 and 9 show an exemplary embodiment of an enlarged region 21 of the stringer part 8 or 9, respectively. The remaining region of the stringer part that has a consistent cross-sectional face transitions into an end portion 25 having a decreasing thickness in the enlarged region 21. The reduction in the thickness is achieved by a successive reduction in the number of laminated tiers, so-called hafting.

The hafted end portion 25 is bonded to a reverse-hafted laminated construction 26 by way of which the stringer part 8 or 9, respectively, increases in terms of thickness as well as in terms of width up to an end region 27 which comprises the abutment face 11 or 12, respectively. Place-holding fillers 29, for example of foam or balsa, in addition to the end portion 25, are situated between tiers of the laminated construction 26.

The end region 27 again has a hafting like the end portion 25, that is to say that the thickness of said end portion 27 slightly decreases toward the abutment face 11 or 12, respectively.

In the example shown, the width of the stringer part 8 or 9, respectively, increases from 0.7 m to 1 m, and the thickness increases from 23 mm to 100 mm.

The enlarged region 21 could also be completely prefabricated and adhesively bonded to the spar in its entirety.

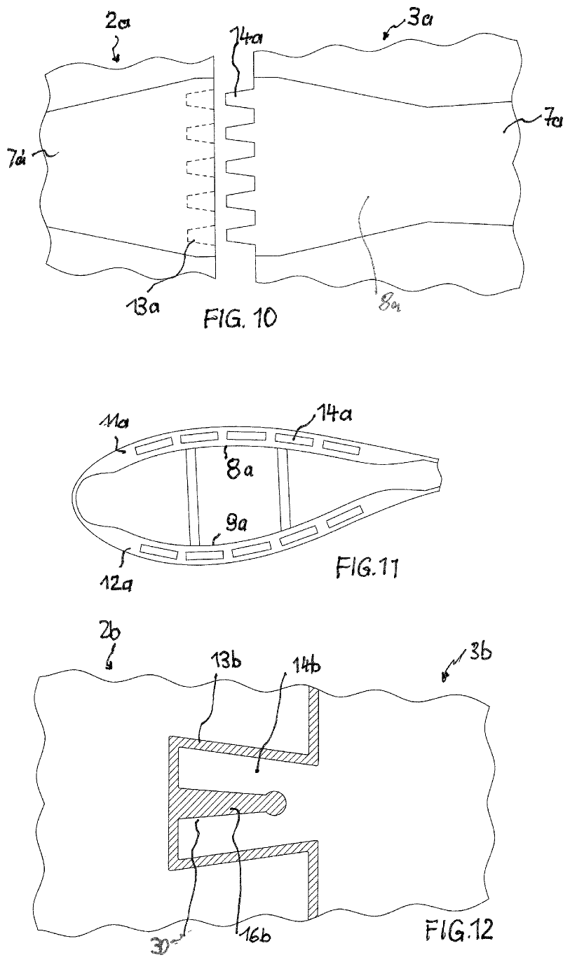

Reference is now made to FIGS. 10 to 12 in which identical or functionally equivalent parts are identified using the same reference sign as in the preceding figures and the respective reference signs have the suffix a or b, respectively.

An exemplary embodiment shown in FIGS. 10 and 11 uses plug-type connection elements 14a instead of pin-connection elements, said plug-type connection elements being integrally connected to enlarged stringer parts 8a and 9a of a spar 7a.

As can be derived from FIG. 11, the plug-type connection elements 14a are configured so as to be flat in the cross section and engage in slot-shaped receptacle recesses 13a in correspondingly enlarged stringer parts of a spar 7a′ of the rotor blade portion 2a. The connection elements 14a are anchored in the receptacle recesses 13a by way of a previously incorporated and cured adhesive compound.

The plug-type connection elements 14a which are flat in the cross section are composed of portions of laminated tiers which project from the enlarged stringer part that per se is formed by laminated tiers. The slot-shaped receptacle recesses 13a are formed by cores which have been removed after the laminating of the respective stringer parts, for example.

In an exemplary embodiment which is illustrated in fragments in FIG. 12, slot-shaped receptacle recesses 13b are undercut and plug-type connection elements 14b which for the purpose of being introduced into the receptacle recesses are deformable engage in the receptacle recesses. The deformation capability of the connection elements 14b results from a wedge-shaped incision 30 having an enlargement at the closed end. Compressible legs are formed on account of the incision 30, said legs expanding again once the connection element 14b has been introduced into the receptacle recess 13b. As can be seen in FIG. 12, the wedge-shaped cutout is filled with cured adhesive compound 16b.

While specific embodiments of the invention have been shown and described in detail to illustrate the inventive principles, it will be understood that the invention may be embodied otherwise without departing from such principles.

I claim:

1. A connection between portions of a rotor blade of a rotor of a wind power plant, said rotor blade being divided transversely with respect to a longitudinal axis of the rotor blade, wherein the rotor blade has a hollow wing profile having a wall shell on a negative-pressure side and a wall shell on a positive-pressure side, as well as a spar which in a cavity between the wall shells runs in a longitudinal direction of the blade and is connected to the wall shells by stringer parts of the spar that face the wall shells, wherein the stringer parts of the spar of the rotor blade portions in a connection region are enlarged while forming mutually opposite abutment faces, receptacle recesses for receiving connection elements that project from the opposite abutment face open in at least one of the abutment faces, and the connection elements are anchored in a materially integral manner in the receptacle recesses.

2. The connection according to claim 1, wherein the connection elements are integrally connected to the stringer part that forms the opposite abutment face, or the connection elements extend into the receptacle recesses which are mutually aligned in pairs in both mutually opposite stringer parts.

3. The connection according to claim 1, wherein the connection elements are pin-connection elements having a circular cross section and the receptacle recesses are bores having a circular cross section.

4. The connection according to claim 3, wherein the receptacle recesses are blind bores.

5. The connection according to claim 1, wherein the connection elements have a flat cross section and the receptacle recesses are configured as correspondingly narrow pockets.

6. The connection according to claim 2, wherein the connection elements that are integrally connected to the opposite abutment face are formed by portions of laminated tiers that protrude from the respective stringer part.

7. The connection according to claim 1, wherein the connection elements are anchored in a form-fitting manner in the receptacle recesses.

8. The connection according to claim 1, wherein the receptacle recesses are undercut, and the connection elements are deformable so as to be introducible into the receptacle recesses.

9. The connection according to claim 1, wherein an end portion that comprises at least one of the enlarged stringer parts is completely prefabricated and is adhesively bonded to a remainder of the spar.

10. The connection according to claim 1, wherein the stringer parts are enlarged in terms of width and optionally in terms of thickness.

11. The connection according to claim 10, wherein the stringer parts are enlarged by way of a laminated construction that is bonded to an endpiece of a remaining stringer part.

12. The connection according to claim 11, wherein the remaining stringer part is a tapered endpiece.

13. The connection according to claim 3, wherein the pin-connection element has a thickening and the abutment faces that bear on one another in the connection region are disposed in a region of the thickening, wherein the pin-connection element comprises conical enlargements that form the thickening.

14. The connection according to claim 13, wherein the thickening is formed by at least one sleeve that is placed onto a main body of the pin connection element and is fastened by adhesive bonding.

15. The connection according to claim 4, further comprising ducts for injecting an adhesive compound which open in each case toward an external side of the blade, as well as check ducts for checking a filling level of a gap between the pin-connection element and the bore wall open out into the blind bores, wherein the check ducts are formed by groove ducts which are incorporated in the abutment faces.

16. The connection according to claim 3, wherein the pin-connection element, the spar including the enlarged stringer parts or/and the wall shells are composed of fiber-composite material.

17. The connection according to claim 16, wherein the spar including the enlarged stringer parts and the wall shells comprise a fiber-composite structure.

18. The connection according to claim 1, wherein the rotor blade portions at the connection end have in each case one cover connected to the rotor blade portion so as to protect the interior of the rotor blade portion.
